(19) United States
(12) Patent Application Publication
(10) Pub. No.: US 2026/0323313 A1
(43) Pub. Date: Oct. 15, 2026

(54) Unified Cellular Network Data Collection and Analysis Architecture

(71) Applicant: DISH Wireless L.L.C., Littleton, CO (US)

(72) Inventors: Kazi Bashir, Lewisville, TX (US); Rajesh Chilka, Littleton, CO (US); Mehdi Alasti, Arlington, VA (US); Jingyi Zhou, Belle Mead, NJ (US); Sourabh Gupta, Ashburn, VA (US)

(21) Appl. No.: 19/178,270

(22) Filed: Apr. 14, 2025

(51) Int. Cl. H04W 24/02; H04L 67/51; H04L 67/56

(52) U.S. Cl. CPC H04W 24/02; H04L 67/51; H04L 67/56

(57) ABSTRACT

Various arrangements for collecting and analyzing cellular network data are presented. A data collection application programming interface function (DCAF) can collect information from a plurality of user equipment (UEs), a plurality of components of a radio access network (RAN), and a RAN intelligent controller (RIC). The DCAF can provide the collected information to an intelligence layer of a cellular network core. The intelligence layer can collect information from network functions of the cellular network core. A network data analytics function (NWDAF) of the cellular network core can then perform an analysis of the information collected from the network functions of the cellular network core and the information provided by the DCAF. In response, the NWDAF can modify the cellular network based on the performed analysis.

### BACKGROUND

The network data analytics function (NWDAF) is a network function (NF) that can exist in the core of a 5G cellular network. The NWDAF can be used to analyze data within the cellular network core to generate analytics data, make recommendations, and take actions intended to optimize network operations, energy consumption, and resource allocation, and also to benefit end users that interact with the cellular network via pieces of user equipment (UEs). The NWDAF can be used to create automation and perform service orchestration within the cellular network core.

Due to the architecture of a conventional cellular network, the NWDAF may have limited ability to obtain information from outside of the core of the cellular network. For example, information from the radio access network (RAN) of the cellular network and UEs themselves may not be used by the NWDAF in performing analytics. Embodiments detailed herein provide architectures for unified data collection that can be used to enhance the ability of the NWDAF to derive analytics information and improve services rendered based on such information.

### SUMMARY

In some embodiments, a unified cellular network data collection system is presented. The system can include a radio access network (RAN) of a cellular network. The system may also include a cellular network core, wherein the cellular network core can be in communication with the RAN. The system can further include a data collection application programming interface function (DCAF). The DCAF may collect information from a plurality of user equipment (UEs). The DCAF can collect information from a plurality of components of the RAN. The DCAF may also collect information from a RAN intelligent controller (RIC). The DCAF can cause the collected information to be transmitted to a data repository of an intelligence layer. The system may include an intelligence layer, which can comprise a network data analytics function (NWDAF) and the data repository. The NWDAF may analyze data obtained from within the cellular network core. The NWDAF can also analyze the information collected by the DCAF and stored in the data repository. The NWDAF may modify the functionality of the cellular network based on analyzing the data obtained from within the cellular network core and the information collected by the DCAF.

Embodiments of such a system can include one or more of the following features. Each of these features can be individually incorporated into the above-detailed system. The DCAF may transmit the information to an application function (AF) of the cellular network core. The AF of the cellular network core can transmit the information to the data repository of the intelligence layer. The DCAF may transmit the information to a network exposure function (NEF) of the cellular network core. The NEF can transmit the information to a service communication proxy (SCP) of the cellular network core. The SCP of the cellular network core may transmit the information to the data repository of the intelligence layer. The DCAF may transmit the information to an NEF of the cellular network core. The NEF of the cellular network core can transmit the information to the data repository of the intelligence layer. The DCAF may transmit the information directly to the data repository of the intelligence layer. The DCAF may transmit the information to an SCP of the cellular network core. The SCP of the cellular network core can transmit the information to the data repository of the intelligence layer. The DCAF may transmit the information to an operations and management (OAM) data domain of the cellular network core. The OAM data domain of the cellular network core can transmit the information to the data repository of the intelligence layer. An external client system may communicate with an interface of the intelligence layer. The external client system can obtain data from within the cellular network core and the information collected by the DCAF. The intelligence layer may be part of the cellular network core. The DCAF, the cellular network core, and the intelligence layer may be hosted using a public cloud computing system. The cellular network may be a 5G New Radio (NR) cellular network.

In some embodiments, a unified cellular network data collection method is presented. The method can include collecting, by a DCAF, information from a plurality of UEs. The DCAF may collect information from a plurality of components of a RAN. The DCAF can also collect information from a RIC. The DCAF may provide the collected information to an intelligence layer of the cellular network. The intelligence layer can collect information from the network functions of a cellular network core. An NWDAF may perform an analysis of the information collected from the network functions of the cellular network core. The NWDAF can also analyze the information provided by the DCAF. The NWDAF may modify the cellular network based on the performed analysis.

Embodiments of such a method can include one or more of the following features. Each of these features can be individually incorporated into the above-detailed method. The collected information can be provided to the intelligence layer of the cellular network core may comprise the DCAF transmitting the information to an AF of the cellular network core. The AF of the cellular network core can transmit the information to a data repository of the intelligence layer. Providing the collected information to the intelligence layer of the cellular network core may comprise the DCAF transmitting the information to an NEF of the cellular network core. The NEF can transmit the information to a SCP of the cellular network core. The SCP may transmit the information to a data repository of the intelligence layer. Providing the collected information to the intelligence layer of the cellular network core may comprise the DCAF transmitting the information to an NEF of the cellular network core. The NEF can transmit the information to a data repository of the intelligence layer. Providing the collected information to the intelligence layer of the cellular network core may comprise the DCAF transmitting the information directly to a data repository of the intelligence layer. Providing the collected information to the intelligence layer of the cellular network core may comprise the DCAF transmitting the information to an SCP of the cellular network core. The SCP can transmit the information to a data repository of the intelligence layer. Providing the collected information to the intelligence layer of the cellular network core may comprise the DCAF transmitting the information to an OAM data domain of the cellular network core. The OAM data domain can transmit the information to a data repository of the intelligence layer. The intelligence layer may be part of the cellular network core. The DCAF, the cellular network core, and the intelligence layer may be hosted using a public cloud computing system.

### BRIEF DESCRIPTION OF THE DRAWINGS

FIG. 1 illustrates an embodiment of a radio access network (RAN) and the core of a cellular network.

FIG. 2 illustrates an embodiment of a unified cellular network data collection system that includes a Data Collection API Function (DCAF) providing information to an intelligence layer via an Application Function (AF).

FIG. 3A illustrates an embodiment of a unified cellular network data collection system that includes a DCAF providing information to an intelligence layer via a Network Exposure Function (NEF) and Service Communication Proxy (SCP).

FIG. 3B illustrates an embodiment of a unified cellular network data collection system that includes a DCAF providing information to an intelligence layer via an NEF.

FIG. 4A illustrates an embodiment of a unified cellular network data collection system that includes a DCAF providing information to an intelligence layer.

FIG. 4B illustrates an embodiment of a unified cellular network data collection system that includes a DCAF providing information to an intelligence layer via an SCP.

FIG. 5 illustrates an embodiment of a unified cellular network data collection system that includes a DCAF providing information to an intelligence layer via an Operations And Maintenance (OAM) data domain.

FIG. 6 illustrates an embodiment of a method for collecting and analyzing cellular network data.

### DETAILED DESCRIPTION

Various architectures, as disclosed herein, can be used to collect information from UEs, a RAN, and/or a RIC. Various communication paths through the cellular network core can be used to pass information from a DCAF that interacts with the UEs, the RAN, and/or the RIC to an intelligence layer. Part of the intelligence layer is an NWDAF, which analyzes data obtained from NFs residing within the cellular network core. By using the information collected by the DCAF and the information obtained by the NWDAF from the cellular network core, data from across the cellular network is unified for analysis. This arrangement allows the NWDAF to analyze a large swarth of data, which can be used to produce analytics and determine how to modify the cellular network.

Different architectures, as detailed herein, can make use of different NFs residing in the core to relay information collected by the DCAF to the intelligence layer. The DCAF can perform one or more functions before delivering the data to the intelligence layer, such as data filtering, verification, and integrity checks. In some embodiments, the application function (AF) operating within the cellular network core is used to relay information obtained by the DCAF to a data store or data repository that functions as part of the intelligence layer and is accessible by the NWDAF. In other embodiments, the DCAF relays information via the NEF and SCP to the datastore of the intelligence layer. In other embodiments, the DCAF relays information via the NEF to the datastore of the intelligence layer. In other embodiments, the DCAF may directly access the datastore of the intelligence layer. In other embodiments, the SCP relays information via the NEF to the datastore of the intelligence layer. In still other embodiments, the OAM data domain in the cellular network core is used to relay information obtained from the DCAF to the datastore of the intelligence layer.

The information corrected by the intelligence layer from the cellular network core and the DCAF can also be analyzed by other parties. For example, client systems, operated by third parties, may be given access to portions of the data collected and stored in the intelligence layer, the analytics created by the NWDAF, or both. For example, a particular client for which a cellular network slice is operated may be granted access to analytics about how their UEs are functioning on the cellular network.

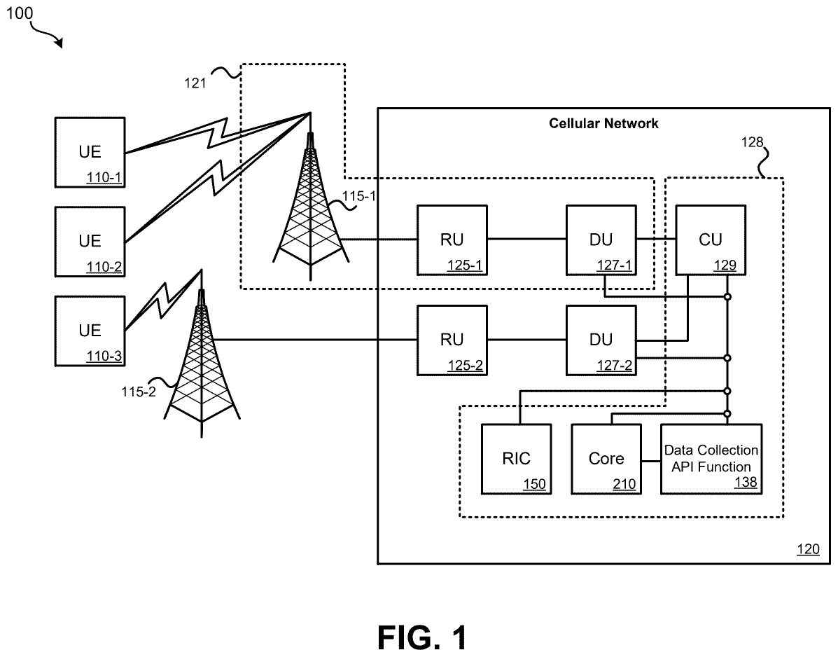

Further detail regarding these embodiments and others is provided in reference to the figures. FIG. 1 illustrates an embodiment of a radio access network and the core of a cellular network, referred to as cellular network system 100 (“system 100”). System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network and beyond are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 210, and data collection API function 138 (“DCAF 138”).

FIG. 1 represents a component-level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed. As an example, a public cloud computing provider, such as Amazon Web Services (AWS) can be used to host cellular network functions in association with an account mapped to the cellular network provider. While other accounts are present and have software executed by the public cloud computing provider, cellular network functions are isolated from such other components and behave as if present on a private cloud platform.

UEs 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UEs can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UEs 110 use RF to communicate with one or more base stations of cellular network 120.

Two base stations 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. In some implementations, the radio access technology (RAT) used by RU 125 is 5G NR. Other implementations use other RAT, such as 4G LTE or a later radio technology related to 6G or beyond. The remainder of the cellular network 120 may be based on an exclusive 5G architecture, a hybrid 4G/5G architecture, a 4G architecture, or some other cellular network architecture (e.g., 6G or beyond).

Base station equipment 121 may include at least one RU, such as RU 125-1, and a DU (e.g., DU 127-1) located on site at the base station. In some embodiments, the DU may be physically remote from the RU. In some embodiments, multiple DUs are housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radio frequency band near 600 Megahertz allocated for cellular communications).

One or more DUs, such as DU 127-1, may communicate with CU 129. Collectively, RUs, DUs, and a CU create a gNodeB, which serves as the RAN of cellular network 120. CU 129 can communicate with the cellular network core 210 (“core 210”). The specific architecture of cellular network 120 can vary by embodiment. Edge cloud server systems (not illustrated) outside of cellular network 120 may communicate, either directly, via the Internet, or via some other network, with components of cellular network 120. For example, one or more DUs 127-1 may be able to communicate with an edge cloud server system without routing data through CU 129 or core 210.

At a high level, the various components of a gNodeB can be understood as follows: RUs perform RF-based communication with UE; DUs support lower layers of the protocol stack such as the radio link control (RLC) layer, the medium access control (MAC) layer, and the physical communication layer; and CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs.

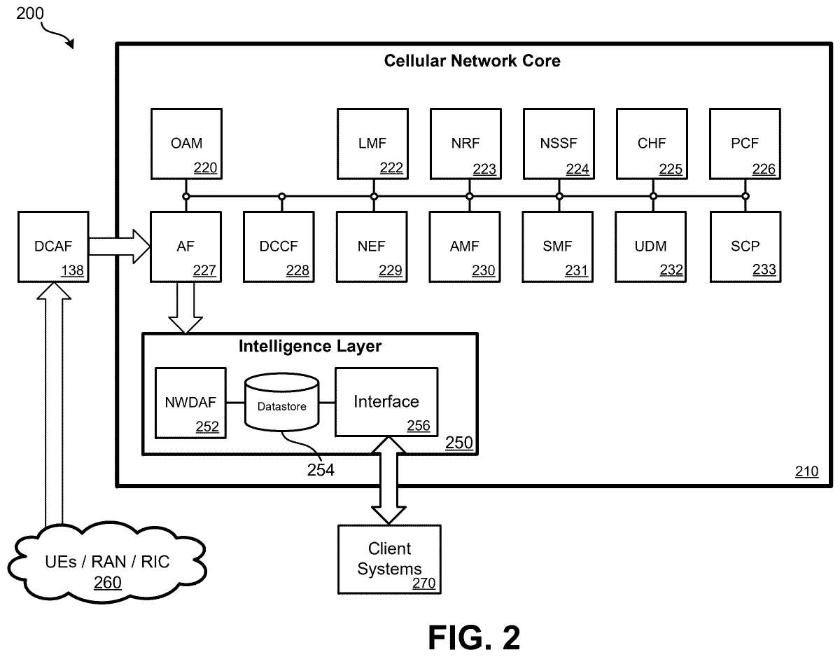

Further details regarding cellular network core 210 is provided in relation to FIG. 2. DCAF 138 may be executed on the same cloud computing system as core 210 or on a separate computing system, which may be directly operated by the cellular network provider. Components 128 of the cellular network 120 can be executed on a cloud computing system, such as a public cloud computing system. DCAF 138 serves the primary purpose of either receiving or actively gathering information from various components of the cellular network. At a high level, DCAF 138 can gather information from UEs 110, components of the RAN, such as RUs 125, DUs 127, CU 129, and RIC 150. Additionally, DCAF 138 can perform functions such as data filtering, verification, and perform integrity checks. These preprocessing steps can help ensure that only relevant, accurate, and high-quality data is transmitted to the intelligence layer, enhancing the efficiency and reliability of the analytics process. In some embodiments, if information is obtained from RIC 150, information directly from RUs, DUs, and/or CUs is not necessary.

RIC 150 can monitor and control RAN components in real-time or near real-time. RIC 150 can coordinate adjustments on the cellular network, such as due to shifting user demand across one or more cellular network slices. Specifically, RIC 150 can control radio resources, such as how bandwidth available to the cellular network is allocated. RIC 150 can further be used for traffic steering, beamforming optimization, slicing, quality of experience, and quality of service optimization. RIC 150 can therefore be in communication with the various components of gNBs of the cellular network, such as including DUs 127 and CUs 129. To maintain the simplicity of FIG. 1, not all communication pathways between RIC 150, DCAF 138, and the RAN components are illustrated. Further details regarding DCAF 138 is provided in relation to FIG. 2.

Each of FIGS. 2-5 represent different architectures of how a DCAF can be used in combination with an NWDAF to provide a unified data collection, and an analysis structure for a cellular network. FIG. 2 illustrates an embodiment of a unified cellular network data collection system 200 (“system 200”) that includes a DCAF providing information to an intelligence layer via an AF. In system 200, a key advantage of its architecture is consistency and simplicity. By utilizing a DCAF as a gateway for RAN and UE analytics data, the data is routed through a single, streamlined access point, enhancing operational efficiency and reducing complexity. System 200 includes cellular network core 210, DCAF 138, UEs/RAN/RIC 260, and client systems 270. Intelligence layer 250 may be incorporated as part of cellular network core 210 or may reside outside of cellular network core 210 but may be executed on the same computing platform.

Cellular network core 210 can be executed on a cloud-computing platform, in a distributed computing environment, or on dedicated hardware operated by a cellular network provider. Within cellular network core 210, various NFs are present. These NFs can communicate with each other and with RAN components. The NFs present in core 210 can vary substantially by embodiment based on the needs of the cellular network provider. Greater or fewer numbers of NFs may be present in a cellular network core. Rather, core 210 is illustrated to include various common cellular network functions and additionally cellular network functions through which DCAF 138 may communicate with intelligence layer 250.

OAM 220 functions as an administrative domain and can be understood as part of core 210 and gathering information from other NFs in core 210. Within OAM 220, various algorithms may be executed that can be used to predict and react to occurrences on the cellular network. Data from OAM 220 can be provided to NWDAF 252 for analysis. Charging function (CHF) 225 is an NF for modeling, building, configuring, and implementing subscriber, network, and application charging and rating plans in real time.

Location management function (LMF) 222 provides positioning functionality by means of determining the geographic position of a mobile device based on downlink and uplink location measuring radio signals. Network Repository Function (NRF) 223 can be a data repository, such as in the form of a database, used to implement registration and discovery of other network services, either in a local or a remote network. Network Slice Selection Function (NSSF) 224 can be used to select the appropriate network slice instance for a given UE based on factors like UE subscription information, service requirements, and network conditions.

5G Policy Control Function (PCF) 226 is a network function that manages policies for 5G networks. PCF 226 can control network behavior and manage resources. Data Collection Configuration Function (DCCF) 228 can interact with unified data management (UDM) 232 to configure how user data is collected for various services. Oracle Communications'NEF is a 5G core cloud native network element that securely exposes the network services and capabilities to either third-party applications or the internal Application Functions (AFs) over the Application Programming Interface (API).

Access and Mobility Management Function (AMF) 230 can handle the registration of UEs to the cellular network. AMF 230 can authenticate the UE and authorize access to the network's services. Session Management Function (SMF) 231 is a control plane NF responsible for session management with the supported individual functions on a per-session basis. UDM 232 is an NF used to control network user data. A stateful form stores data locally to where UDM 232 is running while a stateless form stores data in a unified data repository (UDR).

Service Communication Proxy (SCP) 233 is an NF that manages communication and services in 5G core networks. SCP 233 can manage routing topology, perform load balancing, manage service discovery, perform message routing, manage communication security, and monitor network performance.

Application function (AF) 227 controls applications and provides services to subscribers. AF 227 can perform traffic management, quality of service assignments, enable policy control in association with PCF 226, provide application services, such as video streaming to UEs, and access to resources via NEF 229.

Intelligence layer 250 can include: NWDAF 252, datastore 254 (which can also be referred to as a data repository), and interface 256. Intelligence layer 250 can function as part of cellular network core 210 or can reside outside of the cellular network core. NWDAF 252 is typically within core 210 and in communication with other NFs of the core. NWDAF 252 collects data from within cellular network core 210. This data can be analyzed by NWDAF 252 using various machine learning or artificial intelligence arrangements, such as trained machine learning models. NWDAF 252 can analyze, generate data about, and perform actions in order to improve network performance, such as by allocating resources, orchestrating new instances of functions, and altering the architecture of the cellular network. NWDAF 252 can obtain information from NFs such as AMF 230, NRF 223, PCF 226, SMF 231, and UDM 232.

Datastore 254 can represent a database or other form of data repository where data to be analyzed by NWDAF 252 is stored. Additionally, NWDAF 252 can use the same or different datastore 254 to store the analytics it creates based on the data stored in datastore 254. Additional data can be added to datastore 254 by DCAF 138 that NWDAF 252 would otherwise not have access to. That is, while NWDAF 252 may obtain information from within core 210 from NFs such as AMF 230, NRF 223, PCF 226, SMF 231, and UDM 232, DCAF 138 can obtain and provide information from components outside core 210, such as UEs, the RAN, and the RIC of the cellular network.

Interface 256 can allow authorized external entities to access datastore 254 to obtain access to the information to be analyzed by NWDAF 252 and/or the analytics output by NWDAF 252. Since DCAF 138 provides information to datastore 254, clients systems 270 (e.g., computer systems operated by clients) can access the obtained data and/or analysis performed by NWDAF 252 based on such data (either on a stand-alone basis or in combination with information obtained from NFs within core cellular network core 210). As an example, a client that operates a large number of UEs on the cellular network on a particular slice may be able to obtain analytics from NWDAF 252 about the UEs by accessing datastore 254. The client may be restricted to accessing only information about the client's UEs.

DCAF 138 can function as an application programming interface (API) that retrieves or otherwise obtains information from UEs, components of the RAN, and the RIC. From UEs, examples of data types that can be obtained include: Positioning Reference Signal (PRS) measurements at the UEs for precise positioning and location-based services, and Channel State Information (CSI) for channel adaptation, equalization, and link optimization. From gNBs (including gNB components such as RUs, DUs, and CUs), energy consumption metrics for energy optimization and sustainability efforts can be obtained. Also, from gNBs information about load distribution across different frequency bands in carrier aggregation for efficient load balancing and resource allocation can be obtained. Data from UEs/RAN/RIC 260 can be provided to datastore 254 for future analysis by NWDAF via AF 227. That is, in some embodiments, DCAF 138 routes information (also referred to as data) from UEs/RAN/RIC 260. AF 227 receives this data and then routes it to datastore 254 of intelligence layer 250. Alternatively, the data may be provided directly to NWDAF 252, which can either analyze or store the data. NWDAF 252 can then analyze the data received from DCAF 138 on its own or in combination with data obtained from NFs of the cellular network, such as AMF 230, NRF 223, PCF 226, SMF 231, and UDM 232. Such data from the NFs may be obtained via OAM 220.

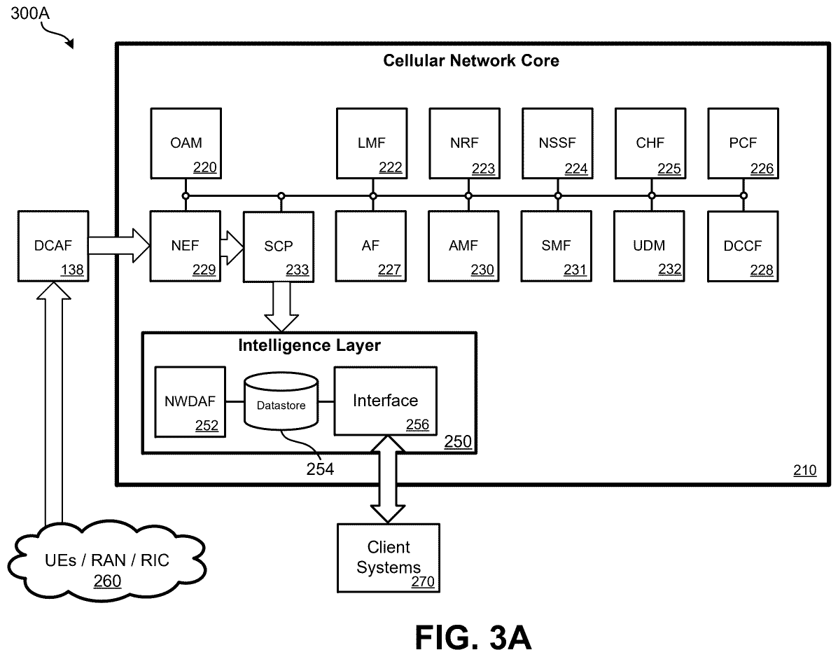

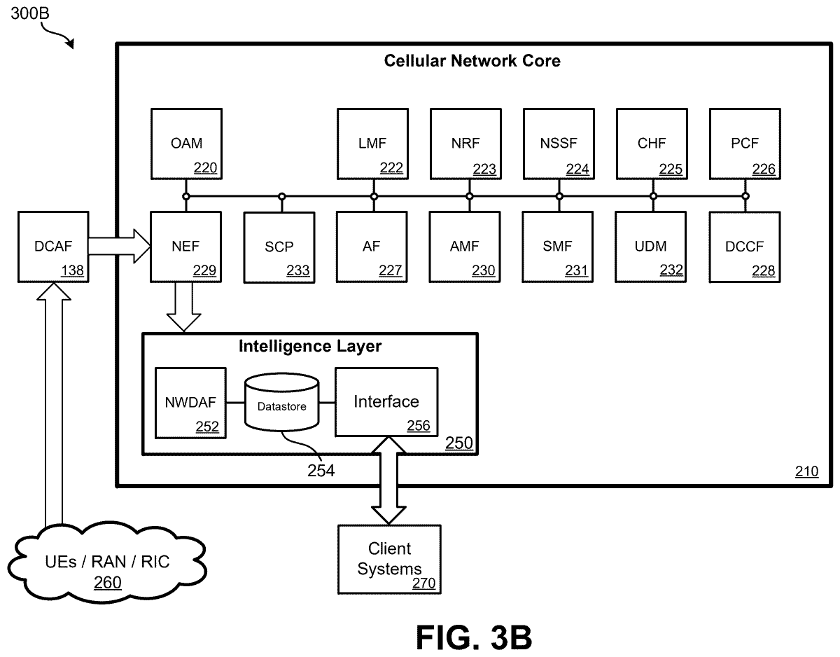

FIG. 3A illustrates an embodiment of a unified cellular network data collection system 300A (“system 300A”) that includes a DCAF providing information to an intelligence layer via a NEF and SCP 233. The components of system 300A function similarly to system 200 of FIG. 2, with the exception that data obtained by DCAF 138 is routed to intelligence layer 250 using a different pathway through the cellular network core 210.

Integrating the NEF with the DCAF can provide at least two advantages: concealing the network topology from the DCAF, which helps ensure security and abstraction; and enabling independent upgrades to the DCAF without impacting the rest of the network, as it operates behind the NEF. Leveraging SCP can enhance 5G network performance and efficiency by simplifying the network topology and optimizing communication flows. Using the SCP can significantly improve network visibility and controllability, allowing operators to manage and monitor traffic more effectively.

In system 300A, data from UEs/RAN/RIC 260 can be provided to datastore 254 for future analysis by NWDAF via SCP 233. That is, DCAF 138 routes information from UEs/RAN/RIC 260 to NEF 229 of the cellular network core 210. NEF 229 then routes the received information to SCP 233. SCP 233 receives this data and then routes it to datastore 254 of intelligence layer 250. Alternatively, the data may be provided directly to NWDAF 252, which can either analyze or store the data. NWDAF 252 can then analyze the data received from DCAF 138 on its own or in combination with data obtained from NFs of the cellular network, such as AMF 230, NRF 223, PCF 226, SMF 231, and UDM 232.

FIG. 3B illustrates an embodiment of a unified cellular network data collection system 300B (“system 300B”) that includes a DCAF providing information to an intelligence layer via a network exposure function (NEF). The components of system 300B function similarly to system 200 of FIG. 2, with the exception that data obtained by DCAF 138 is routed to intelligence layer 250 using a different pathway through the cellular network core 210.

Integrating the NEF with the DCAF can provide at least two advantages: concealing the network topology from the DCAF, which helps ensure security and abstraction; and enabling independent upgrades to the DCAF without impacting the rest of the network, as it operates behind the NEF. While the SCP can offer advantages, the use of the SCP can also introduce a potential single point of failure, which must be mitigated through redundancy and robust failover mechanisms. Thus, avoiding the SCP has advantages.

In system 300A, data from UEs/RAN/RIC 260 can be provided to datastore 254 for future analysis by NWDAF via NEF 229 directly (without using SCP 233). DCAF 138 routes information from UEs/RAN/RIC 260 to NEF 229 of cellular network core 210. NEF 229 then routes the received information to datastore 254 of intelligence layer 250. Alternatively, the data may be provided directly to NWDAF 252, which can either analyze or store the data. NWDAF 252 can then analyze the data received from DCAF 138 on its own or in combination with data obtained from NFs of the cellular network, such as AMF 230, NRF 223, PCF 226, SMF 231, and UDM 232.

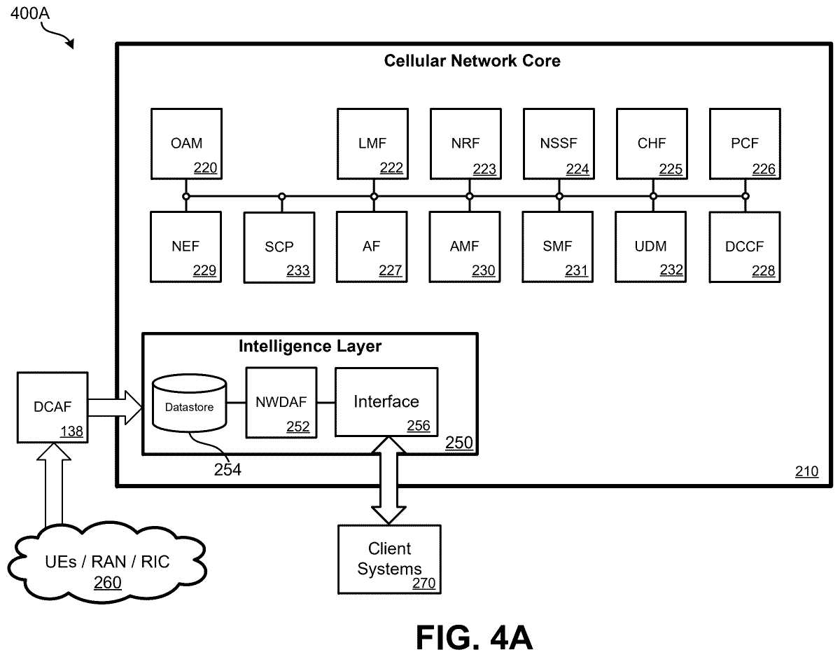

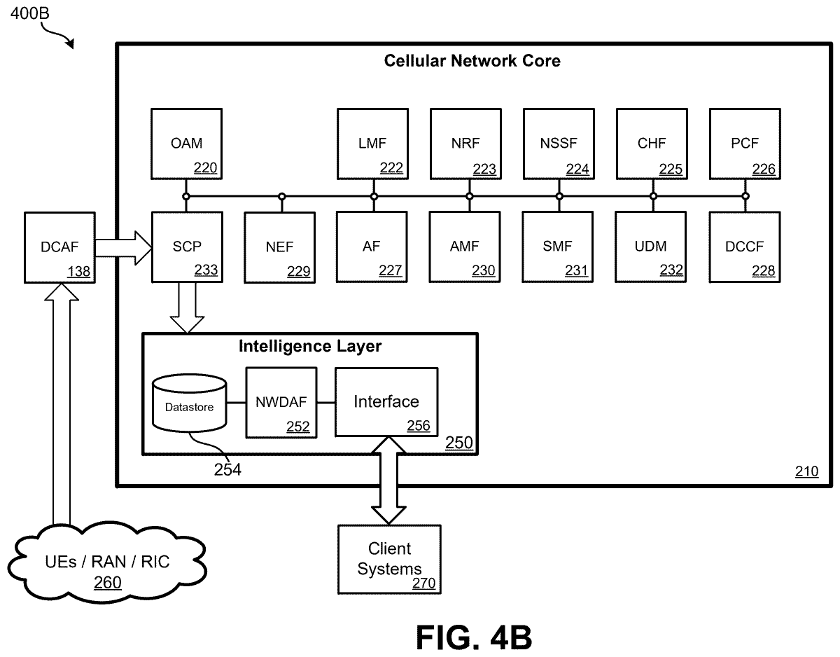

FIG. 4A illustrates an embodiment of a unified cellular network data collection system 400A (“system 400A”) that includes a DCAF providing information to an intelligence layer. The components of system 400A function similarly to system 200 of FIG. 2, with the exception that data obtained by DCAF 138 is routed to intelligence layer 250 using a different pathway through the cellular network core 210.

An advantage of the architecture of system 400A is its consistency and simplicity. By utilizing a unified DCAF as a gateway for RAN and UE analytics data that can efficiently route their data through a single, streamlined access point, enhancing operational efficiency and reducing complexity.

In system 400A, data from UEs/RAN/RIC 260 can be provided to datastore 254 for future analysis by NWDAF directly to datastore 254 without using any other NF of core 210 to relay or reprocess the information. DCAF 138 routes information from UEs/RAN/RIC 260 directly to datastore 254 of intelligence layer 250. Alternatively, the data may be provided directly to NWDAF 252, which can either analyze or store the data. NWDAF 252 can then analyze the data received from DCAF 138 on its own or in combination with data obtained from NFs of the cellular network, such as AMF 230, NRF 223, PCF 226, SMF 231, and UDM 232.

FIG. 4B illustrates an embodiment of a unified cellular network data collection system 400B (“system 400B”) that includes a DCAF providing information to an intelligence layer via an SCP. The components of system 400B function similarly to system 200 of FIG. 2, with the exception that data obtained by DCAF 138 is routed to intelligence layer 250 using a different pathway through the cellular network core 210.

In system 400B, DCAF acts as the gateway for the UE and RAN analytics data, but it could focus on a single point of failure. As previously detailed, transmitting data via the SCP provides advantages, but can also introduce another single point of failure.

In system 400B, data from UEs/RAN/RIC 260 can be provided to datastore 254 for future analysis by NWDAF via SCP 233 of core 210. DCAF 138 routes information from UEs/RAN/RIC 260 to SCP 233, which in turn, routes data to datastore 254 of intelligence layer 250. In some embodiments, SCP 233 performs processing on the data. Alternatively, the data may be provided directly to NWDAF 252 by SCP 233, which can either analyze or store the data. NWDAF 252 can then analyze the data received from DCAF 138 on its own or in combination with data obtained from NFs of the cellular network, such as AMF 230, NRF 223, PCF 226, SMF 231, and UDM 232.

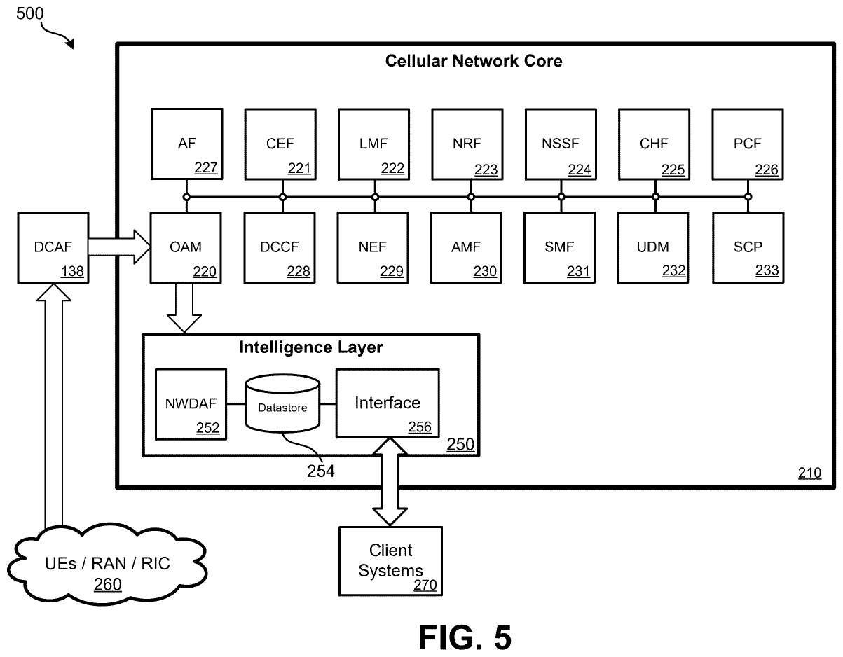

FIG. 5 illustrates an embodiment of a unified cellular network data collection system 500 (“system 500”) that includes a DCAF providing information to an intelligence layer via an operations and maintenance (OAM) data domain. The components of system 400A function similarly to system 200 of FIG. 2, with the exception that data obtained by DCAF 138 is routed to intelligence layer 250 using a different pathway through cellular network core 210.

Since the OAM can directly interface with the NWDAF and receive RAN and UE data, similar to Performance Management (PM) and Fault Management (FM) data, it can serve as a relay between the UE and RAN, efficiently forwarding analytics data to the intelligence layer. This approach can enhance data aggregation, analytics precision, and network intelligence while ensuring seamless integration within the existing network architecture.

In system 400B, data from UEs/RAN/RIC 260 can be provided to datastore 254 for future analysis by NWDAF via OAM 220 of core 210. DCAF 138 routes information from UEs/RAN/RIC 260 to OAM 220, which in turn routes data to datastore 254 of intelligence layer 250. In some embodiments, SCP 233 performs processing on the data. Alternatively, the data may be provided directly to NWDAF 252 by OAM 220, which can either analyze or store the data. NWDAF 252 can then analyze the data received from DCAF 138 on its own or in combination with data obtained from NFs of the cellular network, such as AMF 230, NRF 223, PCF 226, SMF 231, and UDM 232.

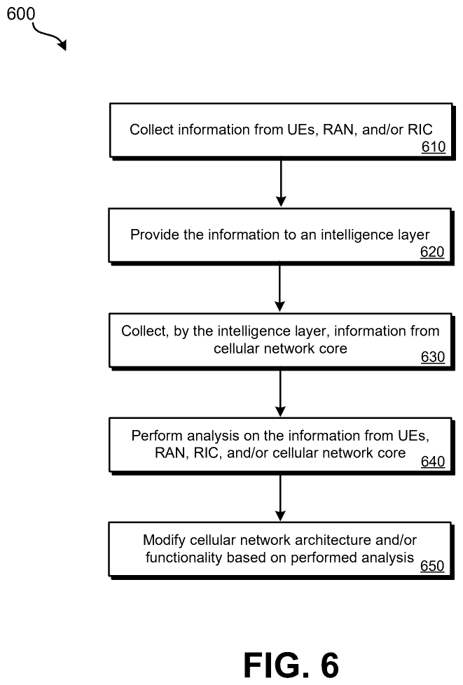

Using any of the system architectures detailed in relation to FIGS. 2-5, a method can be performed. FIG. 6 illustrates an embodiment of a method 600 for collecting and analyzing cellular network data. Method 600 can be performed by any of the systems and system architectures detailed in relation to FIGS. 1-5.

At block 610, the system collects information from UEs, the RAN, and/or the RIC by DCAF 138. DCAF 138 may aggregate information obtained and perform some level of processing on the data, such as to decrease. Following block 610, in block 620, the collected information may be provided to an intelligence layer, ensuring that the data is forwarded to a centralized or specialized layer for further decision-making and analysis. The specific routing through the cellular network core can vary based on the architecture employed. Any of the architecture detailed in relation to FIGS. 2 through 5 can be used to route the data obtained by DCAF 138 to intelligence layer 250.

At block 630, the intelligence layer may also gather information directly from the cellular network core by the NWDAF. The NWDAF may use the OAM to gather information from other NFs of the core. Subsequently, in block 640, the NWDAF may analyze the information obtained from the UEs, RAN, and/or RIC from the DCAF and, possibly, other data gathered by the NWDAF from NFs of the cellular network core. That is, data collected by the DCAF and NWDAF stored in a data repository can be analyzed in concert. This step involves processing the data to derive insights, identify patterns, or detect potential issues that could guide modifications to the cellular network or how UEs are managed.

At block 650, based on the analysis performed using the data obtained by the DCAF and, possibly, the data obtained by the NWDAF from NFs of the core, the NWDAF may provide recommendations on optimizing configurations and settings, modify the cellular network architecture, the cellular network functionality, or provide analytics for review by an administrator or client (e.g., via the client interface). Block 650 can involve applying one or more machine learning models to the data received from the DCAF and the data gathered by the NWDAF from the NFs of the core. For example, a trained neural network can be used to perform an analysis of the received data to determine how the network should be modified. Examples of how the network could be modified include: instantiating another instance of an NF, adding bandwidth between network components, introducing a new data pathway between components of the cellular network, altering properties of a cellular network slice, reassigning UEs between slices, reallocating wireless resources, reassigning UEs to a different anchor point (e.g., UPF), etc. Block 650 allows the network to dynamically adapt, optimize performance, or address problems (e.g., traffic, latency). Collectively, these blocks can represent an iterative process designed to enhance the performance and efficiency of the cellular network, such as by continuously repeating method 600.

The intelligence layer can train a machine learning model based on the data received from the UE/RAN/RIC through the DCAF and then test the trained model using an independent set of testing data for verification purposes. This trained machine learning model can then be deployed in the cellular network, such as by the model being executed at UEs, at the RIC, or elsewhere on the RAN.

Examples of model training and model testing that can be performed at the NWDAF include: Device based positioning in which a UE provides its measurements (GPS, WiFi measurements, etc.) as the collection data and the NWDAF trains a model to map the UE's measurements to a coordinate position of the UE. Another positioning arrangement in which the UE measures the PRS signals and provides information from the PRS signals to the LMF. The LMF can then provide the collected data to NWDAF for model training of the positioning system for the LMF. gNB measurements can also be used for positioning by the gNB measuring SRS signals and provides information based on the SRS signals to the LMF. The LMF can then provide the collected data to NWDAF for model training of the positioning system for LMF. In another example, synchronized signal block (SSB) measurements made at the UE for the beam selection: the UE can measure the SSB signals and can provide the measurements to the NWDAF for model training of the beam selection for the device. In another example, a UE can measure the CSI for channel state information compression in the space domain or perform CSI estimation in the time domain. In this example, the UE collects CSI data and can provide the collected data to the NWDAF for model training. In another embodiment, the gNB can provide the load of each component carrier to the NWDAF for the model training for the load balancing between different component carriers in a carrier aggregation.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the scope of the claims.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the scope of the claims. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A unified cellular network data collection system, comprising:
a radio access network (RAN) of a cellular network;
a cellular network core, wherein the cellular network core is in communication with the RAN;
a data collection application programming interface function (DCAF), wherein:
the DCAF collects information from: 1) a plurality of user equipment (UEs); 2) a plurality of components of the RAN; and 3) a RAN intelligent controller (RIC); and
the DCAF causes the information to be transmitted to a data repository of an intelligence layer; and
the intelligence layer, comprising: a network data analytics function (NWDAF) and the data repository, wherein:
the NWDAF analyzes data obtained from within the cellular network core and the information collected by the DCAF stored by the data repository; and
the NWDAF modifies the functionality of the cellular network based on analyzing the data obtained from within the cellular network core and the information collected by the DCAF.

2. The unified cellular network data collection system of claim 1, wherein the DCAF transmits the information to an application function (AF) of the cellular network core and the AF of the cellular network core transmits the information to the data repository of the intelligence layer.

3. The unified cellular network data collection system of claim 1, wherein:
the DCAF transmits the information to a network exposure function (NEF) of the cellular network core;
the NEF transmits the information to a service communication proxy (SCP) of the cellular network core; and
the SCP of the cellular network core transmits the information to the data repository of the intelligence layer.

4. The unified cellular network data collection system of claim 1, wherein: the DCAF transmits the information to a network exposure function (NEF) of the cellular network core; and the NEF of the cellular network core transmits the information to the data repository of the intelligence layer.

5. The unified cellular network data collection system of claim 1, wherein the DCAF transmits the information directly to the data repository of the intelligence layer.

6. The unified cellular network data collection system of claim 1, wherein: the DCAF transmits the information to a service communication proxy (SCP) of the cellular network core; and the SCP of the cellular network core transmits the information to the data repository of the intelligence layer.

7. The unified cellular network data collection system of claim 1, wherein: the DCAF transmits the information to an operations and management (OAM) data domain of the cellular network core; and the OAM data domain of the cellular network core transmits the information to the data repository of the intelligence layer.

8. The unified cellular network data collection system of claim 1, wherein an external client system communicates with an interface of the intelligence layer to obtain the data obtained from within the cellular network core and the information collected by the DCAF.

9. The unified cellular network data collection system of claim 1, wherein the intelligence layer is part of the cellular network core.

10. The unified cellular network data collection system of claim 1, wherein the DCAF, the cellular network core, and the intelligence layer are hosted using a public cloud computing system.

11. The unified cellular network data collection system of claim 1, wherein the cellular network is a 5G New Radio (NR) cellular network.

12. A method for collecting and analyzing cellular network data of a cellular network, the method comprising:
collecting, by a data collection application programming interface function (DCAF), information from a plurality of user equipment (UEs), a plurality of components of a radio access network (RAN), and a RAN intelligent controller (RIC);
providing, by the DCAF, the collected information to an intelligence layer of the cellular network;
collecting, by the intelligence layer, information from network functions of a cellular network core;
performing, by a network data analytics function (NWDAF), an analysis of the information collected from the network functions of the cellular network core and the information provided by the DCAF; and
modifying, by the NWDAF, the cellular network based on the performed analysis.

13. The method of claim 12, wherein providing the collected information to the intelligence layer of the cellular network core comprises the DCAF transmitting the information to an application function (AF) of the cellular network core and the AF of the cellular network core transmitting the information to a data repository of the intelligence layer.

14. The method of claim 12, wherein providing the collected information to the intelligence layer of the cellular network core comprises:
transmitting, by the DCAF, the information to a network exposure function (NEF) of the cellular network core;
transmitting, by the NEF, the information a service communication proxy (SCP) of the cellular network core; and
transmitting, by the SCP, the information to a data repository of the intelligence layer.

15. The method of claim 12, wherein providing the collected information to the intelligence layer of the cellular network core comprises:
transmitting, by the DCAF, the information to a network exposure function (NEF) of the cellular network core; and
transmitting, by the NEF, the information to a data repository of the intelligence layer.

16. The method of claim 12, wherein providing the collected information to the intelligence layer of the cellular network core comprises transmitting, by the DCAF, the information directly to a data repository of the intelligence layer.

17. The method of claim 12,, wherein providing the collected information to the intelligence layer of the cellular network core comprises:
transmitting, by the DCAF, the information to a service communication proxy (SCP) of the cellular network core; and
transmitting, by the SCP, the information to a data repository of the intelligence layer.

18. The method of claim 12, wherein providing the collected information to the intelligence layer of the cellular network core comprises:
transmitting, by the DCAF, the information to an operations and management (OAM) data domain of the cellular network core; and
transmitting, by the OAM data domain, the information to a data repository of the intelligence layer.

19. The method of claim 12, wherein the intelligence layer is part of the cellular network core.

20. The method of claim 12, wherein the DCAF, the cellular network core and the intelligence layer are hosted using a public cloud computing system.
